(19) United States
(12) Patent Application Publication
(10) Pub. No.: US 2010/0108848 A1
(43) Pub. Date: May 6, 2010

(54) Moving and locating device of padding plate

(76) Inventor: Pi-Chao Chang, Taichung County (TW)

Correspondence Address: Pi-Chao Chang, P.O. Box 44-2049, Taipei, 10668, TW

(21) Appl. No.: 12/289,863

(22) Filed: Nov. 6, 2008

(51) Int. Cl. F16M 13/00

(52) U.S. Cl. 248/349.1

(57) ABSTRACT

The present invention provides a moving and locating device of a padding plate, which could adjust the poker block to control the moving or locating action of the padding plate through a disk with a poker block, along with the preset slot of the padding plate; it is structurally designed in a manner that, a disk is built-into the lower padding plate, and a movable poker block is placed on the disk; when the upper padding plate is mated with the lower padding plate, the snapping relation between the poker block and bottom locating hole of the upper padding plate could be controlled by adjusting the position of the poker block, such that the upper padding plate can be placed in a rotary or fixed state, and switched quickly where necessary.

### BACKGROUND OF INVENTION

1. Field of the Invention

The present invention relates generally to a moving and locating device of padding plate, and more particularly to an innovative one which could change its moving or locating state very conveniently by adjusting the snapping relationship between movable poker block of the disk and locating hole of the padding plate.

2. Description of the Prior Art

In response to the operating requirements at different angles, the padding plate is used for alignment and measurement purposes. Hence, a padding plate structure with rotating angle has been developed. Referring to FIGS. 1, 2, it mainly comprises an upper pad 10 and a lower pad 11; a through-hole 12 is placed centrally onto the lower pad 11, and a rivet 13 is punched to bind the upper pad 10 and lower pad 11; in practice, the lower pad 11 is used as a rotary basement, and upper pad 10 rotates randomly by circling around the rivet 13 to realize multi-angle operation of the padding plate.

However, the following shortcomings are observed during rotation control of the padding plate:

1. Poorer rotation efficiency: as the rivet is mated with the lower pad, the lower pad may be driven to displace the basement when the upper pad is rotated by the operator in the job processing. In such case, the operator must firstly press down the lower pad, and then rotate the upper pad smoothly, making this operation inconvenient.

2. Possible damage of rivet structure: as the rivet is directly fixed onto the upper pad, the rivet structure may be damaged, or disengaged from the padding structure due to long-lasting reverse friction of lower pad or misoperation of the operator.

3. Inability of changing the operating status: the operator cannot, where necessary, adjust the padding plate into rotary or fixed state.

### SUMMARY OF THE INVENTION

In view of the existing shortcomings of the padding plate's rotating structure, the inventor intends to make an improvement by placing a disk into the lower padding plate, where there is a movable poker block. When the upper padding plate is mated with the lower padding plate, the snapping relation between the poker block and bottom locating hole of the upper padding plate could be controlled by adjusting the position of the poker block, such that the upper padding plate can be placed in a rotary or fixed state, where necessary. Another objective of the present invention is to rotate the upper padding plate quickly, flexibly and conveniently by sleeving the disk only with a slot as the disk is not coupled with the upper padding plate. This could eliminate the possible displacement of lower padding plate or damage of rotary mechanism during rotation of the padding plate.

### BRIEF DESCRIPTION OF THE DRAWINGS

FIG. 1 shows an exploded view of the typical rotary padding plate.

FIG. 2 shows an application view of the typical rotary padding plate.

FIG. 3 shows an exploded view of the disk of the present invention.

FIG. 4-1 shows a schematic view 1 of the changing status of poker block of the present invention.

FIG. 4-2 shows a schematic view 2 of the changing status of the poker block of the present invention.

FIG. 5 shows an exploded view of the padding plate of the present invention.

FIG. 6 shows a schematic view of the back of upper top plate of the present invention.

FIG. 7 shows a decomposed view of the padding plate of the present invention.

FIG. 8 shows a sectional view 1 of the preferred embodiment of the present invention.

FIG. 9 shows an application view 1 of the present invention.

FIG. 10 shows a sectional view 2 of the preferred embodiment of the present invention.

FIG. 11 shows an application view 2 of the present invention.

### DETAILED DESCRIPTION OF THE PREFERRED EMBODIMENTS

The structural composition and technical efficacies of the present invention are described below with reference to the preferred embodiments:

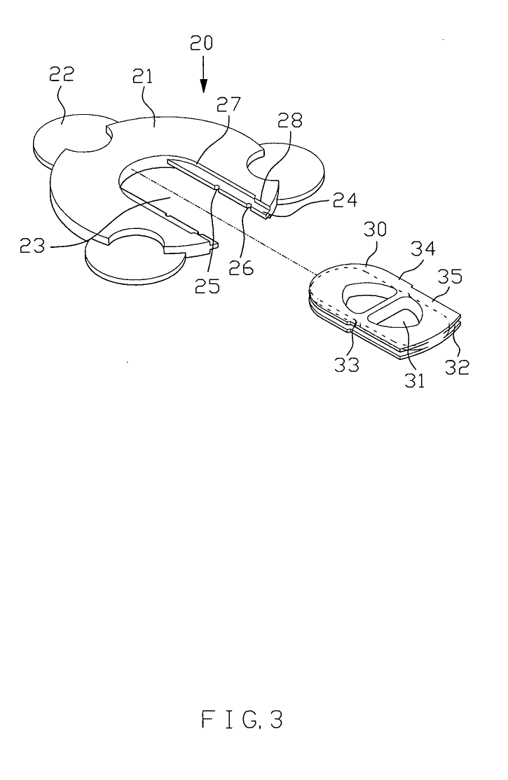

Referring to FIG. 3—an exploded view of the disk, wherein several footsteps 22 are protruded laterally from the disk body 21, while a notched groove 23 is placed internally from outer edge of the disk body 21; a wide/narrow section 27, 28 is formed laterally on the notched groove 23, whilst a track 24 is arranged at both sides of the notched groove 23, and front/rear recessed holes 25, 26 preset correspondingly on two tracks 24; a poker block 30 is built-into the notched groove 23; at both sides of the poker block 30, a groove 32 aligned to the track 24 of notched groove 23 is placed internally, and a bulge 33 is placed correspondingly in the groove 32; a wide/narrow section 34, 35 is also arranged laterally on the poker block 30, and two poker holes 31 are set on the poker block 30, enabling the operator to shift the poker block 30.

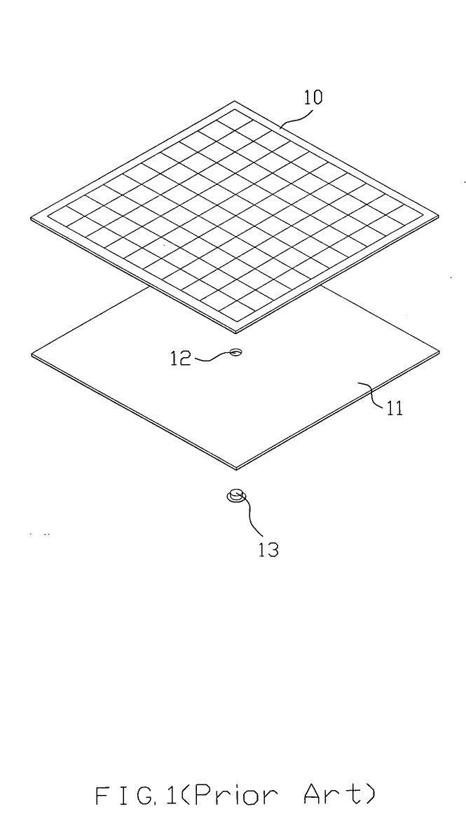

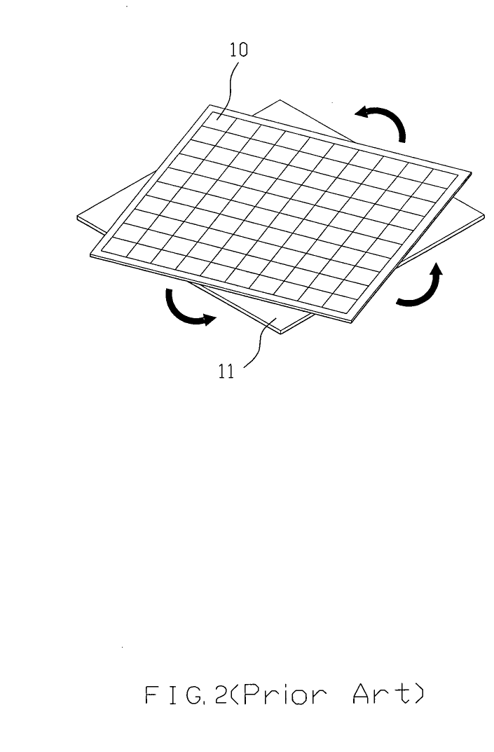

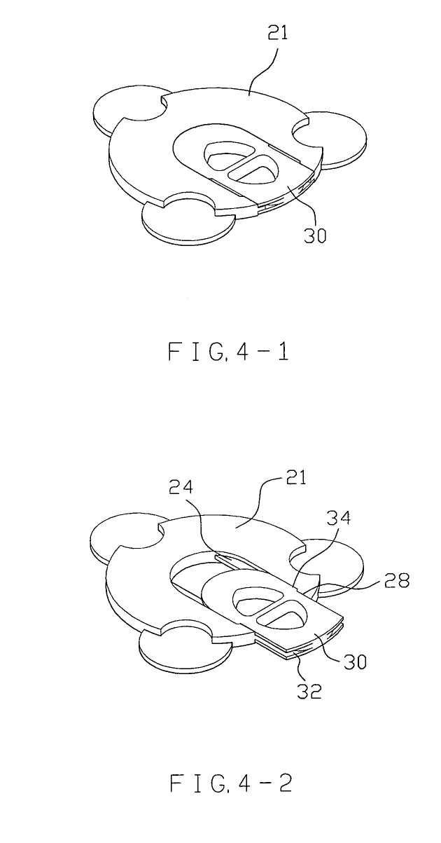

Referring to FIG. 4-1 and 4-2, the poker block 30 can flexibly move within the notched groove 23 of the disk body 21, and the bulge 33 of the groove 32 is locked securely into the front/rear recessed hole 25, 26 of the track 24, then the narrow section 28 of the notched groove 23 could limit the wide section 34 of the poker block 30 against the protrusion of poker block 30.

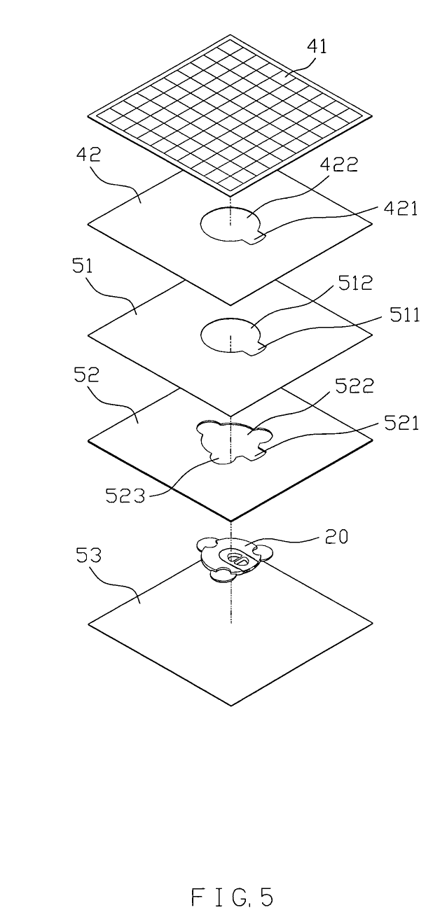

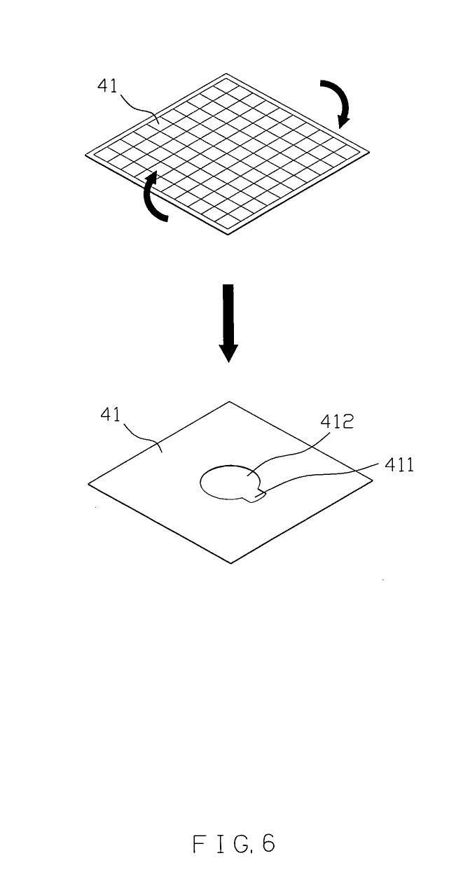

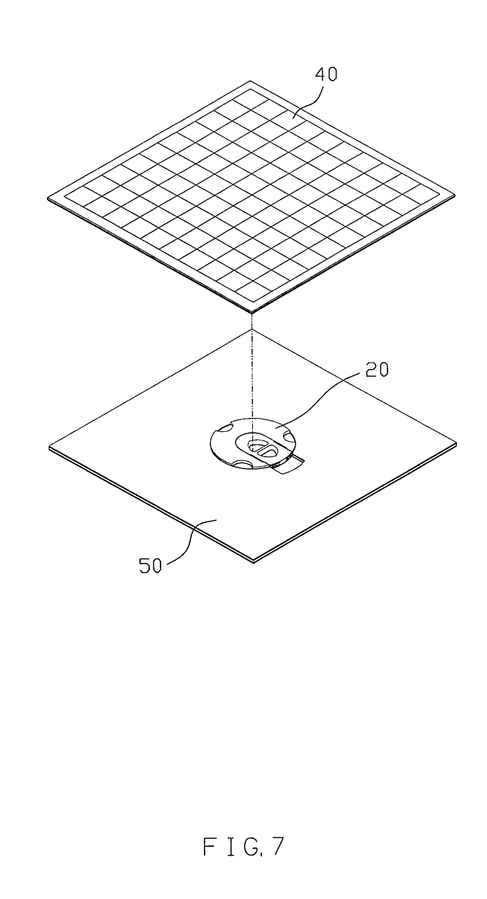

Referring also to FIGS. 5, 6 and 7, it mainly comprises an upper padding plate 40, a lower padding plate 50 and a disk 20; the upper padding plate 40 is composed of an upper top plate 41 and an upper base plate 42; of which, a slot 412 is preset at the bottom of the upper top plate 41, and a locating hole 411 is protruded laterally from the slot 412; the upper base plate 42 is provided with the slot 422 and locating hole 421 correspondingly to the upper top plate 41; the lower padding plate 50 is composed of a lower top plate 51, a lower plywood 52 and a lower base plate 53; of which, the lower top plate 51 and lower plywood 52 are provided with a slot 512, 522, at one side of which a locating hole 511, 521 is arranged; several foot holes 523 corresponding to the footstep 22 of disk 20 are arranged at one side of the slot 522 of the lower plywood 52; moreover, the disk 20 is arranged onto the lower base plate 53, and the lower plywood 52 and lower top plate 51 are overlapped on the lower base plate 53 in sequence, so that the disk 20 can be fixed within the lower padding plate 50; when the upper padding plate 40 is covered on the lower padding plate 50, the disk 20 is mated with the slot 422 of the upper base plate 42.

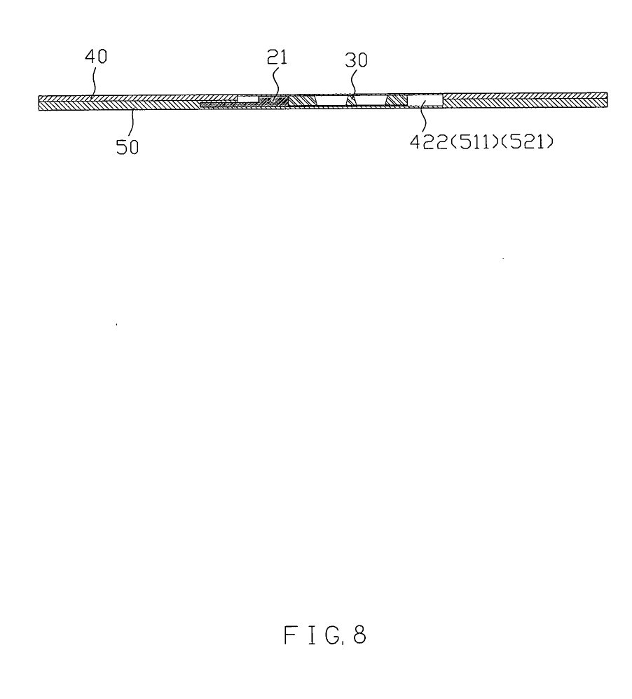

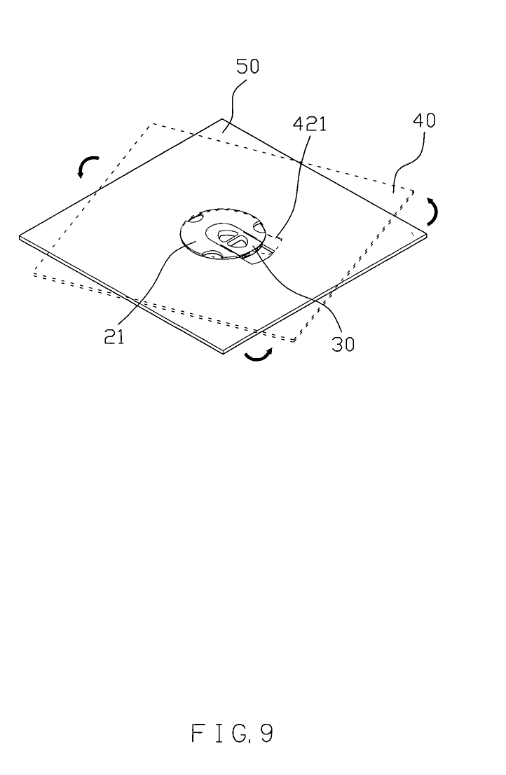

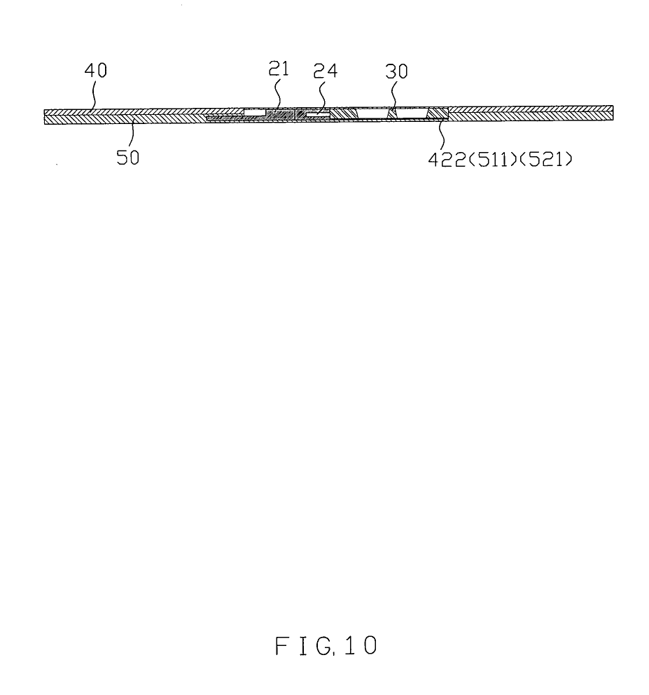

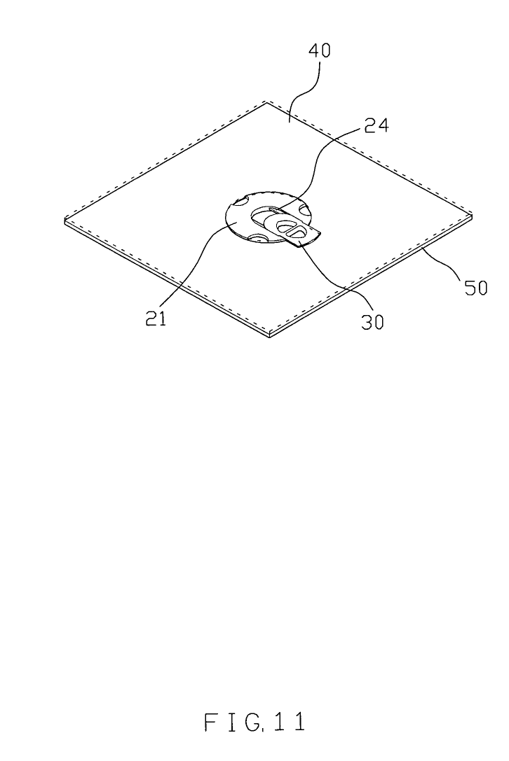

Referring also to FIGS. 8 and 9, when the poker block 30 is recessed into the disk body 21, the poker block 30 is combined with the disk body 21 in a round shape, without any snapping relation with the locating hole 421 of the upper base plate 42. So, the upper padding plate 40 may rotate quickly around the disk 20 in a controlled way; furthermore, referring to FIGS. 10 and 11, when the poker block 30 is extended into the disk body 21 and engaged with the locating hole 511, 521 of the lower top plate 51 and lower plywood 52, the poker block 30 is snapped with the locating hole 421 of the upper base plate 42, so that the upper padding plate 40 is limited in a fixed state; apart from the bonding of the upper padding plate 40 and lower padding plate 50, the upper padding plate 40 could be used independently from the lower padding plate 50.

Although the invention has been explained in relation to its preferred embodiment, it is to be understood that many other possible modifications and variations can be made without departing from the spirit and scope of the invention as hereinafter claimed.

What is claimed is:

1. A moving and locating device of a padding plate, comprising an upper padding plate, a lower padding plate and a disk:
upper padding plate, comprised of an upper top plate and an upper base plate; of which, a slot is preset at the bottom of the upper top plate, and a locating hole is protruded laterally from the slot; the upper base plate is also provided with the slot and locating hole correspondingly to the upper top plate;
lower padding plate, composed of a lower top plate, a lower plywood and a lower base plate; of which, the lower top plate and lower plywood are provided with a slot, a locating hole is arranged at one side of the slot, and several foot holes corresponding to the footstep of disk are arranged at one side of the slot of the lower plywood;
disk, of which comprising:
a disk body, where several footsteps are protruded laterally, while a notched groove is placed internally from outer edge of the disk body; a wide/narrow section is formed laterally on the notched groove, whilst a track is arranged at both sides of the notched groove, and front/rear recessed holes preset correspondingly on two tracks;
a poker block, which is built-into the notched groove of the disk body; at both sides of the poker block, a groove aligned to the track of notched groove is placed internally, and a bulge is placed correspondingly in the groove; a wide/narrow section is also arranged laterally on the poker block, and two poker holes are set on the poker block;
when the upper padding plate is mated with the lower padding plate, the snapping relation of the poker block and the locating hole of upper base plate can be controlled by adjusting the recessed position of the poker block in the disk, so that the upper padding plate can be placed in a rotary or fixed state.

2. The device defined in claim 1, wherein the upper padding plate could be used independently from the lower padding plate.

3. The device defined in claim 1, wherein the upper top plate and upper base plate are of a preset bonding structure.

4. The device defined in claim 1, wherein the lower top plate, lower plywood and lower base plate are of a preset bonding structure.

5. The device defined in claim 1, wherein the disk is assembled into the lower padding plate, and fixed by the slot of the lower top plate and lower plywood, as well as several foot holes of the lower plywood.

6. The device defined in claim 1, wherein the bulge of the groove can be snapped into the front/rear recessed holes of the track when the poker block is recessed.

7. The device defined in claim 1, wherein the wide section of the poker block is limited at the narrow section of the notched groove when the poker block is extended.
